(19) United States
(12) Patent Application Publication
(10) Pub. No.: US 2018/0220803 A1
(43) Pub. Date: Aug. 9, 2018

(54) MULTI-FUNCTION SHELTER SYSTEM

(71) Applicant: Kenneth Blueford, Mansfield, TX (US)

(72) Inventor: Kenneth Blueford, Mansfield, TX (US)

(21) Appl. No.: 15/865,014

(22) Filed: Jan. 8, 2018

Related U.S. Application Data
(60) Provisional application No. 62/443,079, filed on Jan. 6, 2017.

(51) Int. Cl. A47C 19/22; E05B 65/00; F24F 5/00; F24F 7/007; B66F 11/00; G08B 25/01

(52) U.S. Cl. CPC A47C 19/22; E05B 65/00; G08B 25/016; F24F 7/007; B66F 11/00; F24F 5/0096

(57) ABSTRACT

A multi-function shelter system is disclosed for providing in-place sheltering for emergencies, which may be activated and accessed easily and rapidly, giving a user time to protect themselves during emergency events. The system may be implemented as a safety bed system, and includes a protective chamber into which at least one person may enter and seek refuge. The protective chamber may be reinforced to withstand large amounts of force and/or weight. The multi-function shelter system may also include a lifting device, a locking mechanism, a ventilation sub-system, a communication sub-system, and/or an electric sub-system.

### CROSS-REFERENCE TO RELATED APPLICATION

The present application claims the benefit of U.S. Provisional Patent Application No. 62/443,079 filed Jan. 6, 2017 and entitled “SELF-ANCHORING UMBRELLA,” the disclosure of which is incorporated by reference herein in its entirety

### TECHNICAL FIELD

The present invention relates to shelter systems, and more particularly to a multi-function shelter system to protect a user in the event of an emergency.

### BACKGROUND OF THE INVENTION

Emergencies may occur at any time. Oftentimes, a person may have some warning, and may be able to take precautions to deal with the emergency. For example, with adequate warning, a person may be able to seek adequate refuge or shelter. In some case, the person may evacuate the area affected before the event occurs, or may evacuate their home to seek adequate shelter in some other place. In some cases, however, a person may have no warning of the event, or may have limited warning, and this lack of warning may limit the measures and the precautions that can be taken to deal with the emergency. For example, tornadoes, storms, hurricanes, other weather related events, tires, earthquakes, etc. may occur and a person may have limited or no warning of the event. In this case, a person may not be able to leave the home on time or evacuate the area. In yet other unfortunate cases, a person may have to seek refuge in-home, for example as during a home invasion. In such a case, a typical solution has been a “panic room” in which a person may seek refuge and protection. However, access to a panic room may be cut off, depending on the location of the room within the home, and it may take some precious time to get to the room.

This especially true when a person sleeps. In this case, a person may be especially vulnerable, as the person may not realize an emergency is incoming and may miss a warning. Additionally, the person may not have adequate warning to take precautions. It is true that the bedroom, and specifically, a person's bed is considered a very intimate and valuable location where much time is spent. Beds, however, are also easily accessible because “going to bed” is a daily routine performed by most people. Additionally, when in-home refuge may be necessary, such as in a home invasion, a person may have easy access to the bed, as the person may already be in the bed. The present invention is related to a multi-function shelter system to protect a user in the event of an emergency that may be deployed or incorporated as a safety bed system.

### BRIEF SUMMARY OF THE INVENTION

The present invention is directed to apparatuses, systems, and methods which provide a multi-function shelter system. In some embodiments, the multi-function shelter system may be implemented as a safety bed system that may be used during an emergency. The multi-function shelter system may include a protective chamber into which at least one person may enter and seek refuge. In embodiments, the protective chamber may be reinforced to withstand large amounts of force and/or weight. In some implementations, the multi-function shelter system may also include a lifting device, a locking mechanism, a ventilation sub-system, a communication sub-system, and/or an electric sub-system.

In some embodiments of the present disclosure, the multi-function shelter system may operate to provide a bed, while also providing an in-house, in-place shelter for emergencies that may be activated and accessed easily and rapidly, giving a user time to protect themselves during emergency events.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a perspective view of a multi-function shelter system configured in accordance with aspects of the present disclosure;

FIG. 2 shows an open configuration and components of the multi-function shelter system configured in accordance with aspects of the present disclosure;

FIG. 3 shows another perspective view of the open configuration and components of the multi-function shelter system configured in accordance with aspects of the present disclosure;

FIG. 4 shows another view of the multi-function shelter system configured in accordance with aspects of the present disclosure; and

FIG. 5 shows a modular configuration of the multi-function shelter system configured in accordance with aspects of the present disclosure.

### DETAILED DESCRIPTION OF THE INVENTION

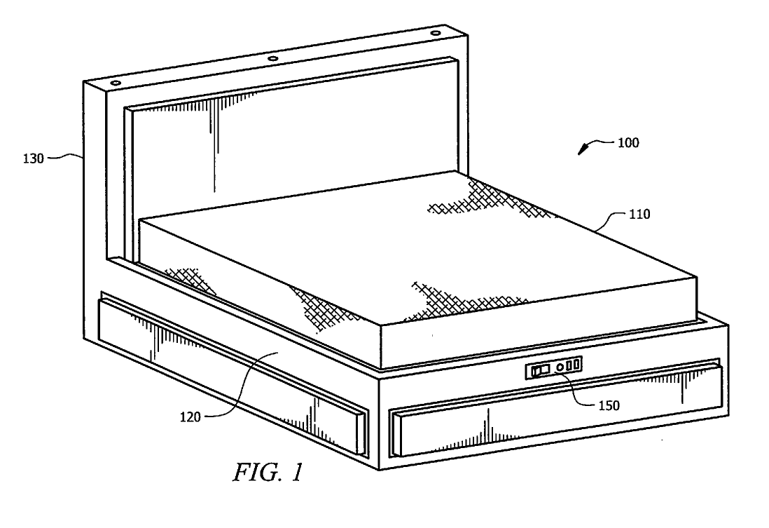

FIG. 1 shows multi-function shelter system 100 configured in accordance with aspects of the present disclosure. Multi-function shelter system 100 may include bed 110, protective chamber 120, and back-frame 130. In some embodiments, back-frame 130 may be integrated with protective chamber 120, as will be discussed in more detail below, or may be a separate component.

Bed 110 may be a typical bed, such as one including a bedframe and a mattress, or may be a specialized bed system configured to facilitate operation and integration with multi-function shelter system 100. Thus, in some implementations, bed 110 may be a platform that attaches to protective chamber 120. In some embodiments, bed 110 may be configured to operate as protective chamber 120's top cover, or lid, and may be configured to withstand large or extreme forces and/or weight. Bed 110 may be made from high-grade, lightweight materials, and may be made from bulletproof or fireproof materials. In some aspects, bed 110 may be configured as a two-section platform. In these implementations, the lower section of bed 110 may pivot with respect to the upper section such that, when in the open-configuration (as will be discussed below), only the lower section separates from protective chamber 120. This provides the advantage that only the lower portion has to be movable with respect to the protective chamber, which may reduce the weight that would have to be lifted to open the multi-function shelter system 100 when activated.

Multi-function shelter system 100 may also include activation mechanism 150. In some embodiments, activation mechanism 150 may be a button, a lever, a switch, etc., configured to activate multi-function shelter system 100. For example, activation mechanism 150 may be triggered or otherwise engaged to deploy multi-function shelter system 100 into the open configuration, as discussed below. In the open configuration, a user may be able to access and enter protective chamber 120. Although activation mechanism 150 is illustrated as positioned in the center of the footboard, it will be appreciated that activation mechanism 150 may be positioned in any convenient place within multi-function shelter system 100. For example, activation mechanism 150 may be positioned on back-frame 130, near where the head of a user may typically be. Additionally, more than one activation mechanisms may be provided for redundancy and convenience. For example, activation mechanisms may be positioned at the foot of the bed, and in each side of back-frame 130.

In some embodiments, activation mechanism 150 may include a security sub-system to allow only authorized users to activate multi-function shelter system 100. Activation mechanism 150 may include a biometric lock, a combination lock, a keyed lock, a password protected lock, or any other means to ensure that only an authorized user may activate the mechanism. In some embodiments, activation mechanism 150 may not perform a security check, and thus, allow anyone to activate multi-function shelter system 100 during initial activation, but may require security checks after the initial activation. In this way, when an emergency occurs, a user does not have to provide security credentials to initially activate and open protective chamber 120. However, subsequent attempts to open the chamber may require security credentials. This may ensure that, for example, a home invader may not open multi-function shelter system 100 after a user has initially activated the shelter and sought refuge within it.

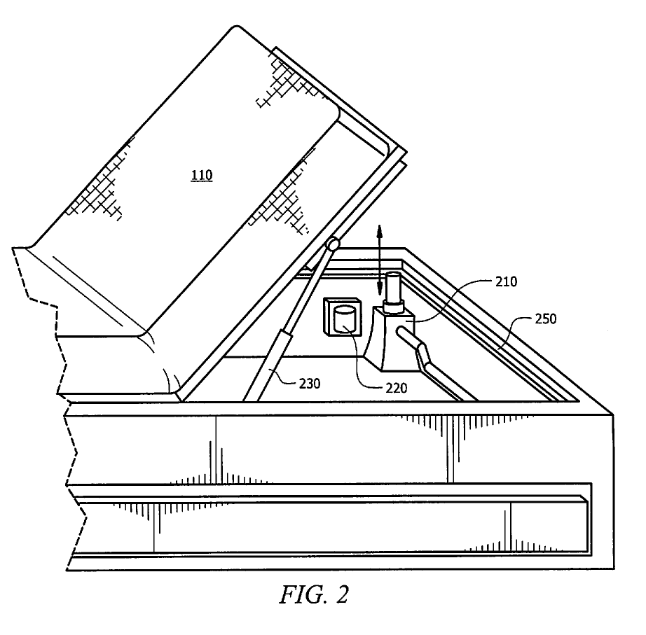

Protective chamber 120 may be configured to provide shelter and protection to a user within it. In embodiments, protective chamber 120 may be configured to be reinforced to withstand large amounts of force and/or weight. For example, in some aspects, protective chamber 120 may be configured to be reinforced to withstand weights of up to 10 tons. In aspects, protective chamber 120 may be made from high-grade, lightweight materials, and may be made from bulletproof or fireproof materials. With reference to FIG. 2, protective chamber 120 may be configured to deploy into an open configuration upon activation of an activation mechanism. In some embodiments, protective chamber 120 may be configured to open without activation from the activation mechanism, but may include a locking mechanism within protective chamber 120 to lock multi-function shelter system 100 after a user has entered protective chamber 120. For example, a user may simply lift the top of protective chamber 120, which in some implementations may be bed 110, and may enter protective chamber 120. Upon entering, the user may activate a locking mechanism (not shown) to prevent protective chamber 120 from opening. In aspects, the locking mechanism may include a biometric lock, a combination lock, a keyed lock, a password protected lock, a mechanical clasp, a bolt, a barrel bolt, or any means for securing bed 110 to protective chamber 120. In some aspects, the locking mechanism may be deactivated internally by the user, thereby allowing protective chamber 120 to be open. In other aspects, the locking mechanism may also be accessible from the outside, but may require security credentials, as discussed above.

Protective 120 may be configured with cushioning along the internal walls. This may provide comfort to users, and may also provide protection in cases where multi-function shelter system 100 may be shaken, or even thrown around during the emergency event. In some embodiments, multi-function shelter system 100 may be secured to a structure, such as the floor of the house. Securing multi-function shelter system 100 may include using bolts, or adhesives.

As shown in FIG. 2, multi-function shelter system 100 may include at least one lifting device 210 configured to provide lifting forces against bed 110 to open multi-function shelter system 100. Lifting device 210 may operate to lift bed 110 even when heavy objects have fallen onto multi-function shelter system 100 during an emergency event. Lifting device 210 may be a jack, such as a hydraulic jack, electric jack, pneumatic jack, or a screwjack. In some aspects, a jack rated between 1 ton and 20 tons may be used. Lifting device 210 may be manually operated, such as a manual jack, or may be a powered jack. It should be appreciate that although the present disclosure discusses multi-function shelter system 100 with respect to a jack device, this discussion is for illustrative purposes only, and should not be construed as limiting, and other lifting devices may be used in accordance with the present disclosure.

In embodiments, multi-function shelter system 100 may include an electric sub-system. The electric sub-system may include at least one light 220, and may include a back-up electric system (not shown). In some aspects, lights 220 may be configured to come on when multi-function shelter system 100 is opened, or may be configured to be manually operated within protective chamber 120. For example, light 120 may be configured with a switch or a push-button to activate it. In some aspects, the back-up electric system may provide power for lights 220, and may also provide power for the communication sub-system, the ventilation sub-system, and lifting device 210. In some embodiments, the back-up electric system may include at least one battery.

In embodiments, multi-function shelter system 100 may include a communication sub-system. The communication sub-system may be configured to provide communication with the outside, with respect to multi-function shelter system 100, for a user within protective chamber 120. In this way, a user may be able to contact emergency services while protected within multi-function shelter system 100. The communication sub-system may include cellular, and/or wi-fi communications. In some aspects, a panic button may be included. A user may activate the panic button and the system may automatically contact emergency services. In aspects, the panic button may be automatically activated upon activation of multi-function shelter system 100, or upon manual opening of multi-function shelter system 100. The system may be configured to provide location, video and/or audio recordings, and special information, such as special needs (e.g., advanced age, medical conditions, etc.) to the emergency services.

In some embodiments, multi-function shelter system 100 may include an entertainment sub-system. The entertainment sub-system may include a screen or monitor, such as a touchscreen, where a user may consume media (such as movies, television, news, etc.), may access the internet, may access email, and/or interact with games.

As further shown in FIG. 2, strut 230 may be included to facilitate opening of multi-function shelter system 100. Strut 230 may cooperatively operate with jack 210 to provide additional opening force. In some embodiments, strut may facilitate initial opening of multi-function shelter system 100, which may be performed without employing 210. This way, a user may be able to manually lift bed 110, which may be made from heavy materials.

Protective chamber 120 may include lip 250. Lip 250 may be configured to stop objects that have fallen onto multi-function shelter system 100 from putting pressure onto lifting device 210. For example, if an object (not shown) falls onto multi-function shelter system 100, lip 250 may provide support for the object such that pressure form the object's weight is stopped by lip 250, thereby preventing lifting device 210 from bearing the weight of the object. In this way, lifting device 210 may be more easily activated to lift, because the pressure from the object's weight may otherwise prevent activation of lifting device 210.

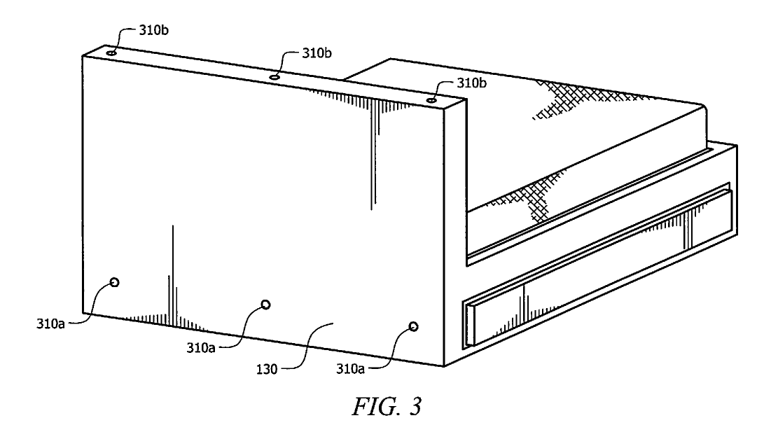

With respect to FIG. 3, multi-function shelter system 100 may include a ventilation sub-system. The ventilation sub-sub-system may be configured to provide circulation of breathable air within protective chamber 120. In this way, a user that has sought refuge within multi-function shelter system 100 is provided a constant supply of fresh air. In some aspects, the ventilation sub-system may include a fan to facilitate air circulation. In some aspects, the ventilation sub-system may include a supply of breathable air, such as compressed air tank, oxygen tank, etc., enclosed within protective chamber 120, and may be released within protected chamber 120 under control of the ventilation sub-system.

In other aspects, the ventilation sub-system may include at least one vent 310a to allow air to circulate through the vent. In some cases, a single vent may be used and configured to allow air to flow in and out. In other aspects, more than one vent may be used and may be configured such that at least one vent is configured to allow air in, but prevent air from going out, and at least one vent is configured to allow air out, but prevent air from coming in. In some aspects, the vents may be configured to be closed-off, such as to prevent water or other materials from entering protective chamber 120. In some aspects, at least one vent 310b may be provided on the higher portion of back-frame 130. In this way, water or other materials in the low areas may be prevented from entering the chamber. This may ensure that the user has a fresh supply of breathable air even during a flood, as the flood waters would have to reach the top portion of back-frame 130 before affective the ventilation sub-system.

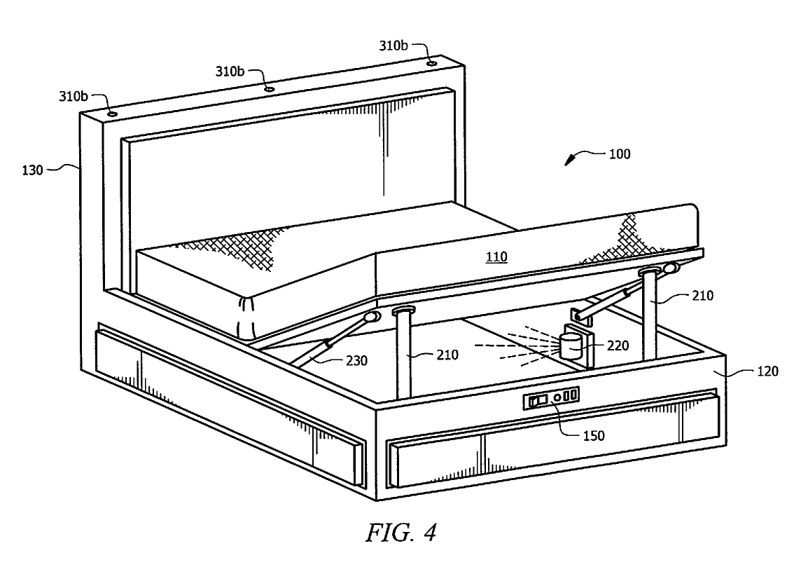

During operation in an emergency event, and with respect to FIG. 4, multi-function shelter system 100 may provide shelter and protection to a user. A user may activate multi-function shelter system 100, for example by using activation mechanism 150, and multi-function shelter system 100 may be deployed to the open configuration. In some embodiments, lifting device 210 may be activated to open multi-function shelter system 100, lifting bed 110 off protective chamber 120. In other embodiments, a user may simply lift bed 110 off protective chamber 120 to open multi-function shelter system 100, instead of activating lifting device 210.

A user may then enter protective chamber 120, and then close multi-function shelter system 100. In some embodiments, closing multi-function shelter system 100 may include reactivating lifting device 210 such that it is lowered, thereby lowering bed 110 onto protective chamber 120. In other aspects, for example where lifting device 210 was not used to open multi-function shelter system 100, the user may simply pull bed 110 down onto protective chamber 120 to close multi-function shelter system 100. In some aspects, a locking mechanism may be activated to prevent multi-function shelter system 100 from re-opening. The locking mechanism may prevent an unauthorized user from opening multi-function shelter system 100 while a user is within protective chamber 120. In some aspects, communication with emergency services may be activated.

After the emergency event has passed, or when it may be determined that it is safe to exit multi-function shelter system 100, a user may open multi-function shelter system 100. In some embodiments, a user activates lifting device 210, which lifts bed 110 off protective chamber 120. The force of lifting device 210 may ensure that multi-function shelter system 100 may be opened despite any objects that may have fallen onto multi-function shelter system 100.

In some aspects, a touchscreen may be provided within protective chamber 120 and may be configured to control different aspects of multi-function shelter system 100. For example, the touchscreen may be used to control activation of lifting device 210, to control activation of the ventilation sub-system, to close or open the ventilation sub-system vents, to turn internal lights on and off, to engage/disengage the locking mechanism, to communicate with external parties, to activate the panic button, etc.

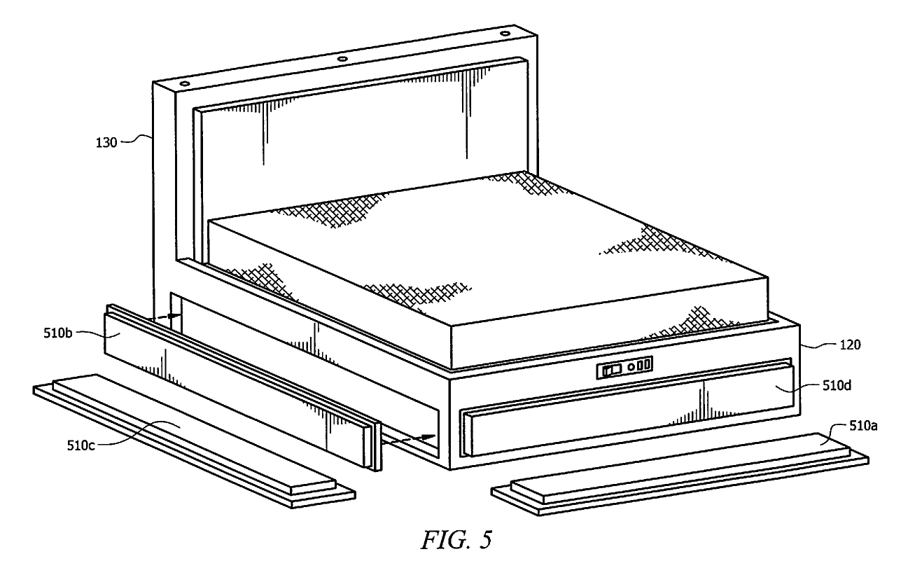

With reference to FIG. 5, multi-function shelter system 100 may be provided as a modular system to provide aesthetically pleasing designs. For example, protective chamber 120 may be provided as a frame chamber, and the exterior of protective chamber 120 may be configured to have interchangeable panels 510a-d. Panels 510a-d may be configured to have various colors, designs, materials, etc. Panels 510a-d may be interchanged by sliding a new panel into place or by using a bolt to secure the panels. Panels 510a-d may have variation of colors, shapes, materials, and styles, and a user may customize the design of multi-function shelter system 100 by selecting combinations from the available panels. The same customization may be provided with respect to back rest 130. In some embodiments, multi-function shelter system 100 may be provided as a protective chamber 120, with a lid, and may not include a back rest or a bed. In these implementations, multi-function shelter system 100 may be used as a stand-alone shelter and may be positioned for easy access, such as, e.g., under an existing bed.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed:

1. A sheltering system for providing multi-function sheltering, said system comprising:
a protective chamber having a top cover and inside walls, wherein said protective chamber is reinforced and configured to accept at least one user within said protective chamber;
a bed configured to rest on said top cover; and
a lifting mechanism, wherein said lifting mechanism is configured to open said protective chamber by lifting said top cover from said protective chamber allowing said user to access said protective chamber.

2. The sheltering system of claim 1, further including a ventilation sub-system configured to allow circulation of air within said protective chamber.

3. The sheltering system of claim 2, wherein said ventilation sub-system includes:
at least one fan configured to cause said circulation; and
at least one vent on said protective chamber, said at least one vent configured to allow said air into said protective chamber.

4. The sheltering system of claim 3, further including a back-frame, said at least one vent is positioned on a top portion of said back-frame, thereby preventing low-lying contaminants from entering said protective chamber.

5. The sheltering system of claim 2, wherein said ventilation sub-system includes a supply of breathable air pumped into said protective chamber.

6. The sheltering system of claim 1, further including a locking mechanism configured to prevent said protective chamber from opening.

7. The sheltering system of claim 6, wherein said locking mechanism is accessible from inside said protective chamber, and is configured to be engaged by an authorized user within said protective chamber, thereby preventing said protective chamber from opening.

8. The sheltering system of claim 6, wherein said locking mechanism is configured to be disengaged only by an authorized user to allow said protective chamber to open.

9. The sheltering system of claim 8, wherein said locking mechanism includes at least one of: a biometric lock, a combination lock, a password lock, and a keyed lock.

10. The sheltering system of claim 1, further including a communication sub-system configured to provide communications with emergency service providers from within said protective chamber.

11. The sheltering system of claim 10, wherein said communication sub-system is configured to automatically contact said emergency service providers upon activation of a panic mode, wherein said panic mode is activated manually by said user or is activated automatically upon said user opening said protective chamber.

12. The sheltering system of claim 1, wherein said top cover is divided into a first portion and a second portion, wherein said first portion is fixed with respect to said protective chamber, and said second portion is configured to pivot with respect to said first portion and to lift from said protective chamber in response to said lifting by said lifting mechanism allowing said user to access said protective chamber.

13. The sheltering system of claim 1, wherein said lifting mechanism includes at least one jack.

14. The sheltering system of claim 13, wherein said at least one jack includes at least one of: a hydraulic jack, electric jack, pneumatic jack, or a screwjack.

15. The sheltering system of claim 14, wherein said at least one jack is a powered jack.

16. The sheltering system of claim 2, further included a back-up power source, wherein said back-up power source provides power to various sub-systems.

17. A device for providing multi-function sheltering, said device including:
a protective chamber having a top cover and inside walls, wherein said protective chamber is reinforced and configured to accept at least one user within said protective chamber;
a lifting mechanism, wherein said lifting mechanism is configured to open said protective chamber by lifting said top cover from said protective chamber allowing said user to access said protective chamber;
a ventilation mechanism configured to allow circulation of air within said protective chamber;
a communication module configured to provide communications with emergency service providers from within said protective chamber;
at least one lighting device configured to provide lighting within said protective chamber; and
a power source for providing power to said ventilation mechanism, communication module, and said at least one lighting device.

18. The device of claim 17, wherein said inside walls are lined with protective material.

19. The device of claim 17, wherein at least one external wall of said protective chamber are configured to accept at least one interchangeable panel.

20. The device of claim 19, wherein said at least one interchangeable panel includes a plurality of panels having at least a different one of a color, material, and design.
